(19) United States
(12) Patent Application Publication
(10) Pub. No.: US 2016/0347247 A1
(43) Pub. Date: Dec. 1, 2016

(54) Vehicle Mountable Safety Light System

(71) Applicants: Paul Espey, Shakopee, MN (US); Gregory Jones, New Market, MN (US)

(72) Inventors: Paul Espey, Shakopee, MN (US); Gregory Jones, New Market, MN (US)

(21) Appl. No.: 14/721,666

(22) Filed: May 26, 2015

(51) Int. Cl. B60Q 7/00; B60Q 1/26

(52) U.S. Cl. CPC B60Q 7/00; B60Q 1/26

(57) ABSTRACT

A vehicle mountable safety light system includes a vehicle with a hitch receiver. A hitch bar is removably extended into the hitch receiver and a post extends upwardly from the hitch bar. A tube with open first and second ends is mounted on the post. A housing is mounted within the tube and is positionable in a stored position within the tube, a left deployed position extending outwardly of the first end of the tube or in a right deployed position extending outwardly of the second end of the tube. The housing has a rearward surface facing away from the vehicle. A plurality of light emitters is mounted in the housing and emits light outwardly of the rearward surface when the light emitters are turned on. The light emitters are spaced along a length of the housing and are turned on when the housing is moved outwardly of the tube.

### BACKGROUND OF THE DISCLOSURE

### Field of the Disclosure

The disclosure relates to vehicle mounted traffic directing light devices and more particularly pertains to a new vehicle mounted traffic directing light device for safely directing traffic around a vehicle.

### SUMMARY OF THE DISCLOSURE

An embodiment of the disclosure meets the needs presented above by generally comprising a vehicle including a hitch receiver extending off of a rear end of the vehicle. A hitch bar is removably extended into the hitch receiver and has a distal end with respect to the hitch receiver. A post is attached to and extends upwardly from the hitch bar adjacent to the distal end. A tube is mounted on an upper end of the post. The tube is elongated and has a first end and a second end each being open. The tube is oriented perpendicular to the post. A housing is mounted within the tube and is positionable in a stored position within the tube, a left deployed position extending outwardly of the first end of the tube or in a right deployed position extending outwardly of the second end of the tube. The housing has a rearward surface facing away from the vehicle. A plurality of light emitters is mounted in the housing and emits light outwardly of the rearward surface when the light emitters are turned on. The light emitters are spaced along a length of the housing and are turned on when the housing is moved outwardly of the tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a vehicle mountable safety light system according to an embodiment of the disclosure.

FIG. 2 is a rear view of an embodiment of the disclosure.

FIG. 3 is a side view of an embodiment of the disclosure.

FIG. 4 is a cross-sectional view of an embodiment of the disclosure taken along line 4-4 of FIG. 2.

FIG. 5 is a perspective view of an embodiment of the disclosure.

FIG. 6 is a schematic view of an embodiment of the disclosure.

### DESCRIPTION OF THE PREFERRED EMBODIMENT

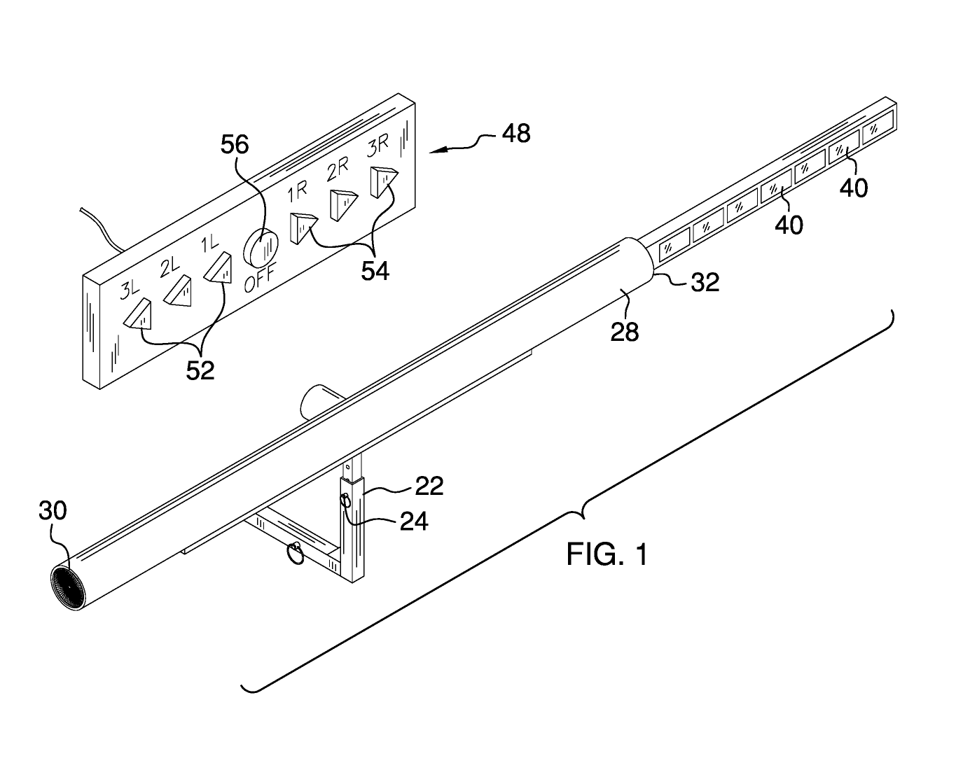

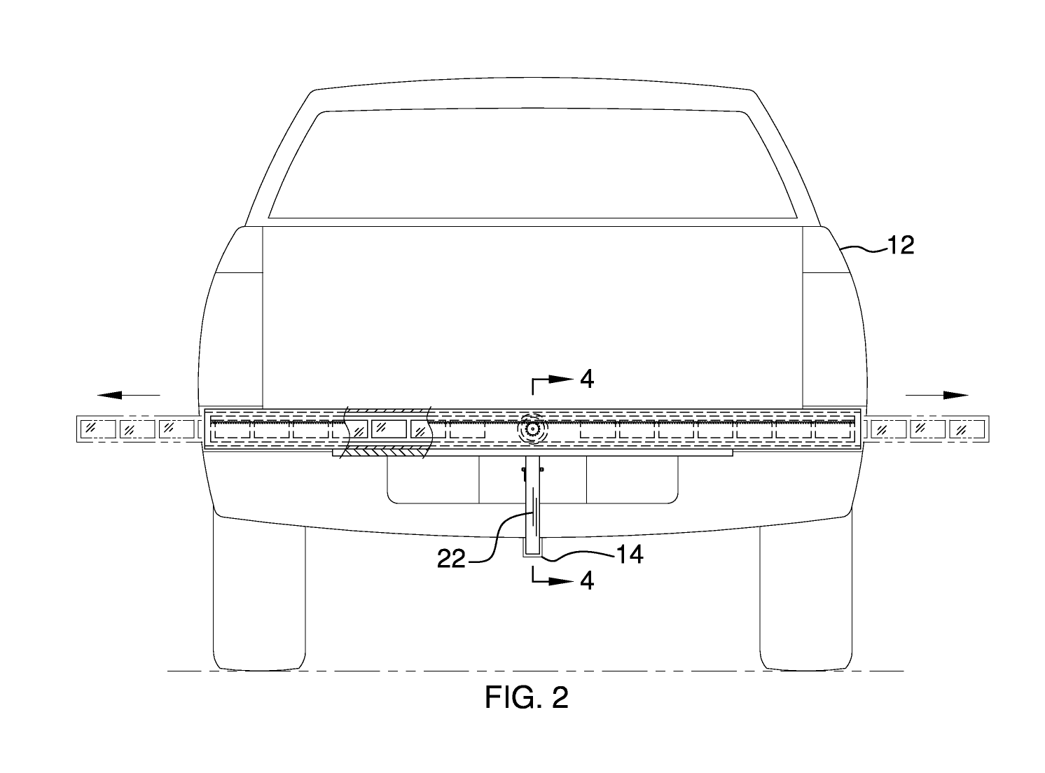

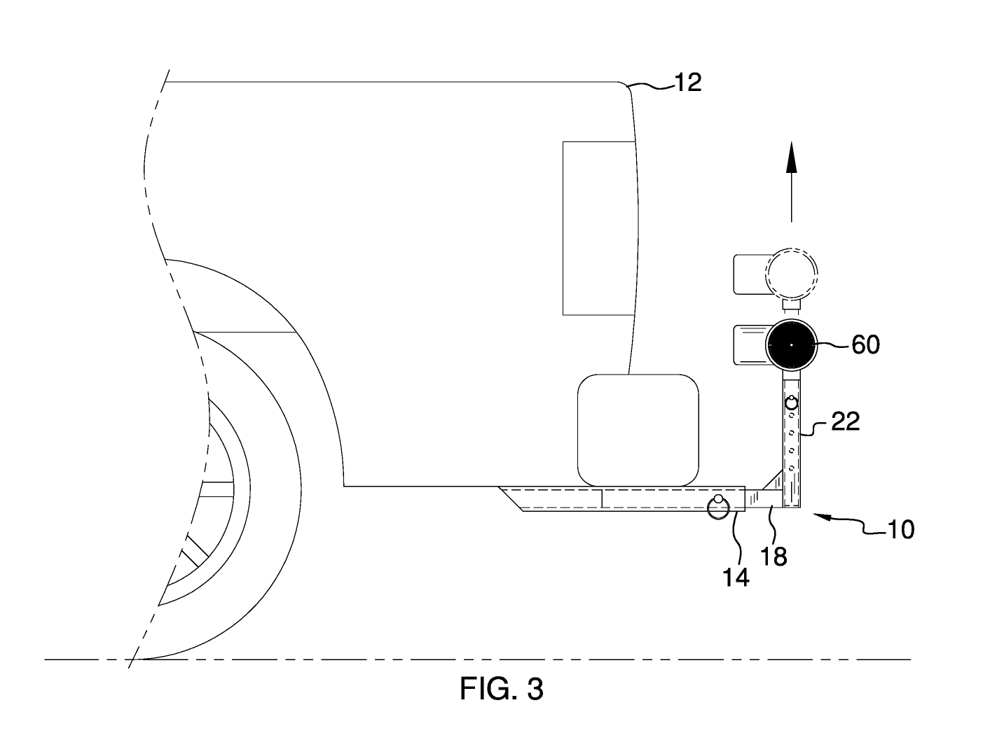

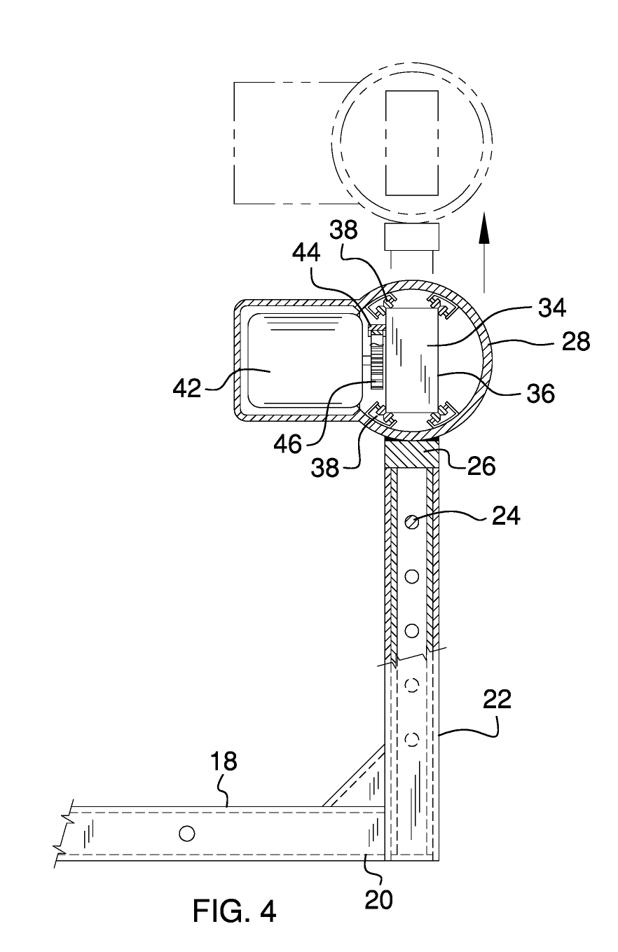

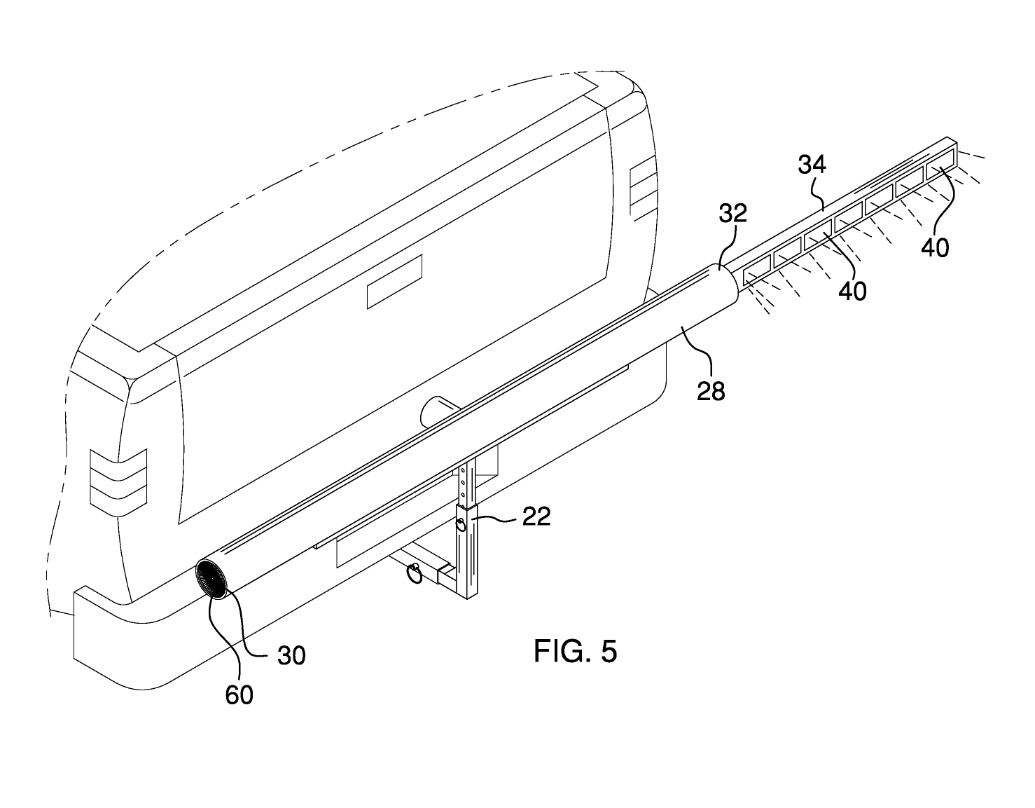

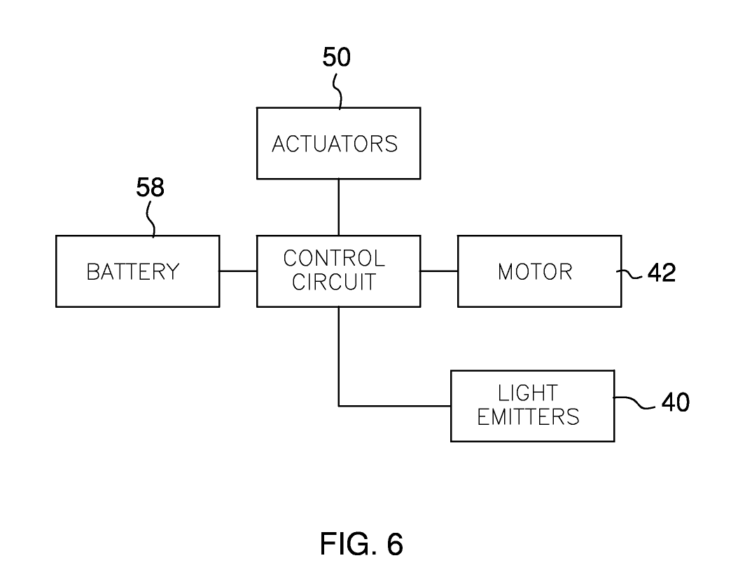

With reference now to the drawings, and in particular to FIGS. 1 through 6 thereof, a new vehicle mounted traffic directing light device embodying the principles and concepts of an embodiment of the disclosure and generally designated by the reference numeral 10 will be described.

As best illustrated in FIGS. 1 through 6, the vehicle mountable safety light system 10 generally comprises a conventional vehicle 12 that includes a hitch receiver 14 extending off of a rear end 16 of the vehicle 12. A hitch bar 18 is removably extended into the hitch receiver 14. The hitch bar 18 has a distal end 20 with respect to the hitch receiver 14. A post 22 is attached to and extends upwardly from the hitch bar 18 adjacent to the distal end 20. The post 22 is telescopic and has an adjustable height. A pin 24 is extendable through post sections to secure the post 22 at a selected height. The post 22 has an upper end 26.

A tube 28 is mounted on the upper end 26. The tube 28 is elongated and has a first end 30 and a second end 32 each being open. The tube 28 is oriented perpendicular to the post 22. The post 22 has a length between 3.0 feet and 6.0 feet. A housing 34 is mounted within the tube 28 and is mounted on rollers 38 to allow the housing 34 to move easily along a length of the tube 28. The housing 34 is positionable in a stored position within the tube 28, a left deployed position extending outwardly of the first end 30 of the tube 28 or in a right deployed position extending outwardly of the second end 32 of the tube 28. The housing 34 has a rearward surface 36 facing away from the vehicle 12.

A plurality of light emitters 40 is mounted in the housing 34 and emit light outwardly of the rearward surface 36 when the light emitters 40 are turned on. The light emitters 40 are spaced along a length of the housing 34. The light emitters 40 may comprise light emitting diodes of any color but may in particular be colored red or yellow. A motor 42 is mechanically coupled to the housing 34. The housing 34 may include a rack 44 that is engaged by a gear 46 coupled to the motor 42. The motor 42 moves the housing 34 with respect to the tube 28. The motor 42 is an electric motor and rotates the gear 46 in a first direction or a second direction.

A control 48 is electrically coupled to the motor 42 and to the light emitters 40. The control 48 is actuated to move the housing 34 relative to the tube 28. The control 48 includes a plurality of selector actuators 50 that are actuated to move the housing 34 between the left deployed, right deployed and stored positions. Thus, when a left actuator 52 is actuated the housing 34 will move to the left deployed position and when a right actuator 54 is actuated the housing 34 will move to the right deployed position. A store actuator 56 may be used move the housing 34 to the stored position. As can be seen in the Figures, the left 52 and right 54 actuators may each include multiple intermediate actuators to allow the housing 34 to be incrementally movable outwardly of the first 30 and second 32 ends of the tube 28. Thus, for instance, the housing 34 may be moved right or left outwardly of the housing 1.0 foot, 2.0 feet or 3.0 feet. The light emitters 40 are turned on when the housing 34 is moved outwardly of the tube 28 and turned off when the housing 34 is in the stored position. Each of the motor 42 and light emitters 40 may be powered by a battery 58 which may or may not the vehicle's battery. The control 48 may be hardwired to the motor 42 and light emitters 40 or the control 48 may wirelessly control the motor 42 and light emitters 40.

A plurality of cleaning bristles 60 is provided. The cleaning bristles 60 are mounted in the tube 28 and clean the housing 34 when the housing 34 moves through the tube 28. Each of the first 30 and second 32 ends has bristles 30 mounted adjacent thereto. Thus, the housing 34 is cleaned after each usage of the light emitters 40.

In use, hitch receiver 14 is used to mount the tube 28 to the vehicle 12 and the post 22 may be adjusted to place the tube 28 at a desired height. When a user of the system 10 wants to direct traffic around a vehicle 12, the user extends the housing 34 to indicate the route passing cars are to take. The light emitters 40 may be programmed so that they flash or turn off on in sequence to indicate the desired direction of re-routing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle mountable safety light system comprising:
a vehicle including a hitch receiver extending off of a rear end of the vehicle;
a hitch bar being removably extended into said hitch receiver, said hitch bar having a distal end with respect to said hitch receiver;
a post being attached to and extending upwardly from said hitch bar adjacent to said distal end;
a tube being mounted on an upper end of said post, said tube being elongated and having a first end and a second end each being open, said tube being oriented perpendicular to said post, said tube being opaque wherein an interior of said tube is obscured from being viewed;
a housing being mounted within said tube, said housing being positionable in a stored position within said tube wherein said housing is obscured from being viewed, a left deployed position extending outwardly of said first end of said tube or in a right deployed position extending outwardly of said second end of said tube, said housing having a rearward surface facing away from said vehicle; and
a plurality of light emitters being mounted in said housing and emitting light outwardly of said rearward surface and away from said rear end of said vehicle when said light emitters are turned on, said light emitters being spaced along a length of said housing, said light emitters being turned on and visible outside of said tube when said housing is moved outwardly of said tube.

2. The vehicle mountable safety light system according to claim 1, wherein said post is telescopic and has an adjustable height.

3. The vehicle mountable safety light system according to claim 1, further including:
a motor being mechanically coupled to said housing, said motor moving said housing with respect to said tube; and
a control being electrically coupled to said motor and to said light emitters, said control being actuated to move said housing relative to said tube, said control including a plurality of selector actuator, said selector actuators being actuated to move said housing between said left deployed, right deployed and stored positions.

4. The vehicle mountable safety light system according to claim 3, wherein said housing is incrementally movable outwardly of said first and second ends of said tube.

5. The vehicle mountable safety light system according to claim 1, further including a plurality of cleaning bristles, said cleaning bristles being mounted in said tube and cleaning said housing when said housing moves through said tube.

6. The vehicle mountable safety light system according to claim 5, wherein each of said first and second ends has bristles mounted adjacent thereto.

7. A vehicle mountable safety light system comprising:
a vehicle including a hitch receiver extending off of a rear end of the vehicle;
a hitch bar being removably extended into said hitch receiver, said hitch bar having a distal end with respect to said hitch receiver;
a post being attached to and extending upwardly from said hitch bar adjacent to said distal end, said post being telescopic and having an adjustable height, said post having an upper end;
a tube being mounted on said upper end, said tube being elongated and having a first end and a second end each being open, said tube being oriented perpendicular to said post, said tube being opaque wherein an interior of said tube is obscured from being viewed;
a housing being mounted within said tube, said housing being positionable in a stored position within said tube wherein said housing is obscured from being viewed, a left deployed position extending outwardly of said first end of said tube or in a right deployed position extending outwardly of said second end of said tube, said housing having a rearward surface facing away from said vehicle;
a plurality of light emitters being mounted in said housing and emitting light outwardly of said rearward surface and away from said rear end of said vehicle when said light emitters are turned on, said light emitters being spaced along a length of said housing;
a motor being mechanically coupled to said housing, said motor moving said housing with respect to said tube;
a control being electrically coupled to said motor and to said light emitters, said control being actuated to move said housing relative to said tube, said control including a plurality of selector actuators, said selector actuators being actuated to move said housing between said left deployed, right deployed and stored positions, said housing being incrementally movable outwardly of said first and second ends of said tube, said light emitters being turned on and visible outside of said tube when said housing is moved outwardly of said tube; and
a plurality of cleaning bristles, said cleaning bristles being mounted in said tube and cleaning said housing when said housing moves through said tube, each of said first and second ends having bristles mounted adjacent thereto.
